(19) United States
(12) Patent Application Publication
(10) Pub. No.: US 2019/0163871 A1
(43) Pub. Date: May 30, 2019

(54) OUTCOME-BASED CONTRACTS

(71) Applicant: INTERNATIONAL BUSINESS MACHINES CORPORATION, ARMONK, NY (US)

(72) Inventors: Francisco Phelan Curbera, Hastings On Hudson, NY (US); Daniel Dias, Mohegan Lake, NY (US); Stacey R. Long, Horseheads, NY (US)

(21) Appl. No.: 15/823,709

(22) Filed: Nov. 28, 2017

(51) Int. Cl. G06F 19/00; G06Q 20/40

(52) U.S. Cl. CPC G06F 19/328; G06F 19/327; G06F 21/6245; G06F 19/322; G06Q 20/40

(57) ABSTRACT

A method, computer system, and computer program product for generating an outcome-based healthcare contract is provided. The embodiment may include defining an outcome-based contract template between a company and a payer, whereby the outcome-based contract template comprises at least one category of a plurality of patient data to be tracked. The embodiment may include generating a contract for a patient based on the outcome-based contract template, whereby at least one specific value associated to the patient is assigned to each at least one category, and whereby the contract comprises a target outcome for the patient. The embodiment may include monitoring the plurality of patient data associated with the patient. The embodiment may include determining the target outcome is achieved based on the plurality of patient data. The embodiment may include transmitting a plurality of outcome data between the company and the payer based on the determined target outcome being achieved.

### BACKGROUND

The present invention relates, generally, to the field of computing, and more particularly to payment systems.

A payment system is a system used to process transactions, usually monetary transactions, between entities. Typically, a payment system operates as a network that creates a monetary exchange between individual accounts, such as bank accounts, to allow for the transfer of money. Payment systems may be physical or, with the rise of computing, electronic. Payment systems may include debit cards, credit cards, electronic fund transfers, direct credits, direct debits, internet banking, and e-commerce payment systems.

### SUMMARY

According to one embodiment, a method, computer system, and computer program product for generating an outcome-based healthcare contract is provided. The embodiment may include defining an outcome-based contract template between a company and a payer, whereby the defined outcome-based contract template comprises at least one category of a plurality of patient data to be tracked. The embodiment may also include generating a contract for a patient based on the defined outcome-based contract template, whereby at least one specific value associated to the patient is assigned to each at least one category, and whereby the contract comprises a target outcome for the patient. The embodiment may further include monitoring the plurality of patient data associated with the patient. The embodiment may also include determining the target outcome is achieved based on the plurality of monitored patient data. The embodiment may further include transmitting a plurality of outcome data between the company and the payer based on the determined target outcome being achieved.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating an outcome-based contracting process according to at least one embodiment;

FIG. 3 is a functional block diagram of an outcome-based contracting platform according to at least one embodiment;

FIG. 4 is a block diagram of internal and external components of computers and servers depicted in FIG. 1 according to at least one embodiment;

FIG. 5 depicts a cloud computing environment according to an embodiment of the present invention; and

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to payment systems. The following described exemplary embodiments provide a system, method, and program product to, among other things, create and monitor an outcome-based contract between a company and a payer, and validate a patient outcome and payment of the outcome-based contract. Therefore, the present embodiment has the capacity to improve the technical field of payment systems by improve payment process efficiency in outcome-based contracts.

As previously described, a payment system is a system used to process transactions, usually monetary transactions, between entities. Typically, a payment system operates as a network that creates a monetary exchange between individual accounts, such as bank accounts, to allow for the transfer of money. Payment systems may be physical or, with the rise of computing, electronic. Payment systems may include debit cards, credit cards, electronic fund transfers, direct credits, direct debits, internet banking, and e-commerce payment systems.

Payment models in the healthcare field are experiencing a shift from a fee-for-service model to an outcome-based care model. Fee-for-service healthcare relates to paying a healthcare provider for services rendered based on billing and fee schedules. Outcome-based care, or value-based care, may be a model of healthcare that ties payment for services to the quality of the care provided to the patient and incentivizes healthcare providers for efficiency and effectiveness of care. An area of focus that has precipitated the shift to a outcome-based model in the healthcare industry is a heightened awareness to the high cost of drugs. For example, oncological and other specialty drugs can cost hundreds to thousands of dollars for a single dose regardless of the outcome experienced by the patient.

Outcome-based healthcare models begin by establishing a contract between insurance companies and pharmaceutical and medical device companies based on measured outcomes for specific patients. The contracts establish payments be due once the patient is healed and provide incentives to care providers for efficiently and effectively administering care. However, payment processes and times under a outcome-based model may increase already onerous burdens experienced in fee-for-service models. As such, it may be advantageous to, among other things, implement a system capable of automating the outcome-based payment process, for cases where the devices, such as medical device, Internet of Things devices, and mobile devices, can measure some or all of the defined outcomes as well as conditional or adherence requirements for patients.

According to one embodiment, an outcome-based contract template may be defined between a pharmaceutical or medical device company and a payer including any key patient data and metrics associated with payments that may be tracked. A specific contract may be created from the template for a particular patient with specific values for the metrics and associated payments. Automated monitoring of patient data may also be implemented in the contract for a patient. While it may not be possible to automatically monitor all patient health parameters, the growing number of mobile frameworks, such as Apple ResearchKit® (ResearchKit and all ResearchKit-based trademarks and logos are trademarks or registered trademarks of Apple Corporation and/or its affiliates) and HealthKit™ (HealthKit and all HealthKit-based trademarks and logos are trademarks or registered trademarks of Apple Corporation and/or its affiliates), and medical devices that measure an increasing number of health parameters combined with health and wellness data may make automated monitoring more feasible for a larger fraction of such contracts. Furthermore, automated analysis of the monitored data may be performed to define the outcomes specified in the contract. Secure exchange of outcome data may be performed with integrity, traceability, auditability, and provenance using blockchain technology. Additionally, outcome validation and payment by the payer may be implemented based on the contract.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to implement an automated outcome-based payment process that is capable of measuring patient data to determine when a defined outcome has been reached, and facilitate an outcome validation and payment process by the payer.

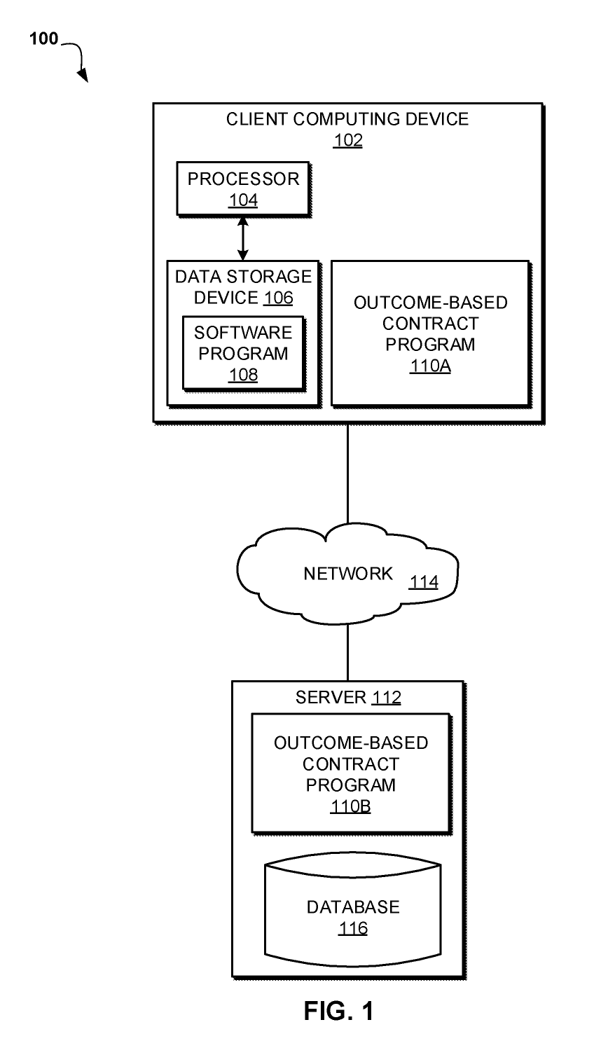

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112 of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

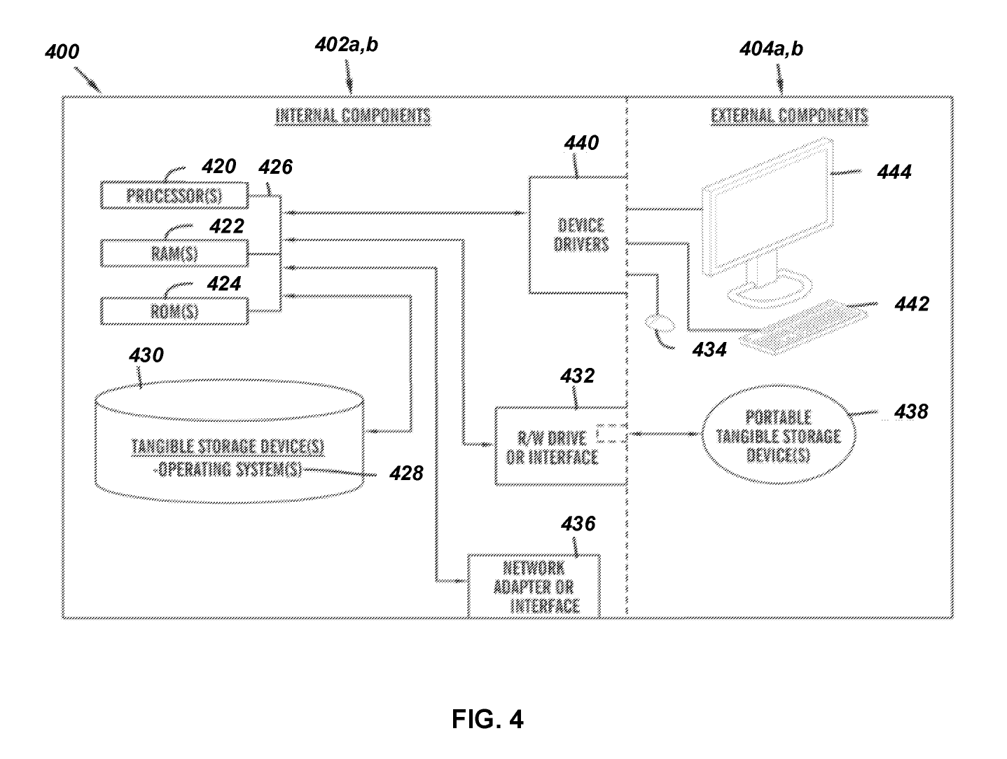

Client computing device 102 may include a processor 104 and a data storage device 106 that is enabled to host and run a software program 108 and an outcome-based contract program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running an outcome-based contract program 110B and a database 116 and communicating with the client computing device 102 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

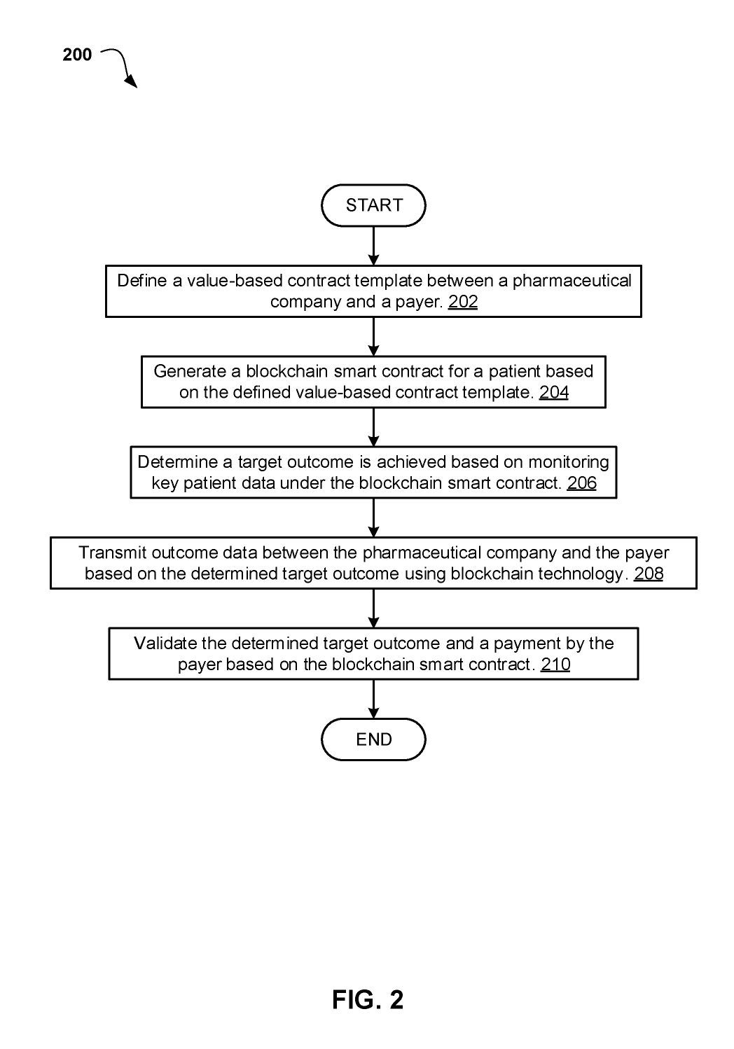

According to the present embodiment, the outcome-based contract program 110A, 110B may be a program capable of establishing an outcome-based contract between a pharmaceutical or medical device company and a payer and receiving patient data relevant to the outcome-based contract. The outcome-based contract program 110A, 110B may monitor the received patient data until the patient has reached a desired outcome defined in the outcome-based contract. Upon reaching the desired outcome, the outcome-based contract program 110A, 110B may validate the outcome and process a payment from the payer based on the outcome-based contract. The outcome-based health purchasing method is explained in further detail below with respect to FIG. 2.

FIG. 2 is an operational flowchart illustrating a speaker coaching process 200 according to at least one embodiment. At 202, the outcome-based contract program 110A, 110B defines an outcome-based contract template between a company and a payer. When establishing a relationship, a company, such as a pharmaceutical or medical device company, may establish an outcome-based contract template for a particular diagnosis code (e.g., in ICD 9/10). The outcome-based contract template may also include guidelines for the drug administration for a diagnosis code, the outcome measurements and metrics, and the payment based on the specific measured outcomes. In at least one embodiment, the outcome-based contract template may include conditional items that may be required for the patient to satisfy. For example, if the patient is diabetic, the patient may be required, under the outcome-based contract template, to walk at least a threshold value of steps per day and ingest a specific drug with a specific time period of the day.

Then, at 204, the outcome-based contract program 110A, 110B generates a blockchain smart contract for a patient based on the defined outcome-based contract template. When a patient is diagnosed, the outcome-based contract program 110A, 110B may utilize the outcome-based contract template to generate an instance of the contract specific to the patient by either using default values in the outcome-based contract template or by having specific values entered for the patient. In at least one embodiment, a service or medical provider or a pharmacy worker may enter the specific values into the patient contract. However, in at least one other embodiment, the patient may enter the values into the contract.

The outcome-based contract program 110A, 110B may allow for conditional items within the in the patient contract. In at least one embodiment, the patient may be required to consent to any conditional item added to the patient contract. The outcome-based contract program 110A, 110B may also require patient consent for monitoring data to be collected by the outcome-based contract program 110A, 110B while informing the patient of the people or entities that are made privy to the collected data and for what purpose each individual would need access to the collected data. For example, service providers and payers may need access to the collected patient data in healthcare situations to verify patient outcomes. In at least one embodiment, the outcome-based contract program 110A, 110B may utilize blockchain technology to enable the patient consent process.

Next, at 206, the outcome-based contract program 110A, 110B determines a target outcome is achieved based on monitoring patient data under the blockchain smart contract. Once the contract for a specific patient is created, the outcome-based contract program 110A, 110B may monitor patient data, such as the outcome measurements and metrics and patient conditional items, to determine when a target outcome has been achieved. The patient data monitored by the outcome-based contract program 110A, 110B may be captured by devices, such as mobile devices (e.g., smartphones) utilizing installed applications, medical monitoring devices (e.g., a continuous glucose monitoring (CGM) device or home-health monitoring system) or wearable technology (e.g., fitness or activity trackers and smartwatches) implementing one or more sensors (e.g., heart rate monitors, accelerometers, glucose monitors, and gyroscopes). The devices capturing the monitored data may be registered through and connected to the outcome-based health purchasing program 110A, 110B via a secure cloud monitoring system, such as Watson Health™ (Watson Health and all Watson Health-based trademarks and logos are trademarks or registered trademarks of International Business Machines Corporation and/or its affiliates), that may receive and store the monitored data in a Health Insurance Portability and Accountability Act of 1996 (HIPAA)-enabled data store. Furthermore, in addition to storing the monitored data for the specific patient, the outcome-based contract program 110A, 110B may de-identify the monitored data from the specific patient and store the de-identified data with other de-identified monitoring data for research purposes.

In at least one embodiment, in order to analyze the patient data and make a determination that a target outcome has been achieved, the outcome-based contract program 110A, 110B may need to gather additional patient data from other sources, such as electronic medical records (EMR), claims, and images. The gathered data may be retrieved through gateways in the cloud to the specific data sources that retain the additional patient data. Additionally, other entities may provide patient data, such as medical labs, pharmacies, distributors, or other institutions. The outcome-based contract program 110A, 110B may utilize the additional patient data to compute outcome metrics, such as ranges for A1C or glucose levels achieved over specific time periods for diabetics, blood pressure ranges or distribution achieved over time for hypertension, peak flow meter longitudinal analysis for asthmatics, forced expiratory volume in one second (FEV1) longitudinal analysis and a six minute walk test longitudinal analysis for sufferers of chronic obstructive pulmonary disease (COPD). The outcome-based contract program 110A, 110B may conduct a more complex analysis that incorporates other technologies. For example, magnetic resonance imaging (MRI) analytics may be used to determine progression free time for a tumor, which may be used as a metric of an oncology drug.

Furthermore, in at least one other embodiment, the outcome-based contract program 110A, 110B may analyze the measured patient conditional data to determine whether the patient has satisfied the requirements under the contract. For example, if the patient is required to exercise a certain period of time each day, a fitness tracker may gather data related to the patient's movements so satisfaction of the conditional requirement that the patient exercise each day may be determined.

Then, at 208, the outcome-based contract program 110A, 110B transmits the outcome data to the company and the payer based on the determined target outcome using blockchain technology to ensure data integrity, trust, and transparency as well as establish a secure audit trail. Once the monitored patient data reflects that a patient has reached a target outcome outlined in the generated contract, the outcome-based contract program 110A, 110B may transmit the outcome data to the company and the payer. The outcome-based contract program 110A, 110B may exchange the monitored outcome data between each entity participating in the contract transaction (e.g., the pharmaceutical or medical device company, the payer, the service provider, and regulators) using known blockchain technology for security, integrity and provenance of the process.

In at least one embodiment, the outcome-based contract program 110A, 110B may also store the monitored data in an indelible record, such as a blockchain network where records are chained in order to make changes to the records very difficult, to maintain integrity through auditable records. Furthermore, the outcome-based contract program 110A, 110B may submit the patient data values via application programming interfaces (APIs) to blockchain smart contracts which could compute the outcomes specified in the contracts. Once a target outcome is reaches, the outcome-based contract program 110A, 110B may transmit the appropriate data to each participant within the blockchain network.

Next, at 210, the outcome-based contract program 110A, 110B validates the determined target outcome and a payment by the payer based on the generated blockchain smart contract. The outcome-based contract program 110A, 110B may record the outcome metrics along with the monitored data on which the metrics may be based in a repository, such as database 116, so each outcome metric and payment can be reproduced and validated, if necessary. Similar to recording the monitored data, the outcome-based contract program 110A, 110B may store the outcome metrics in an indelible record to ensure data integrity. The validation may be performed for each payment or by a sampling methodology.

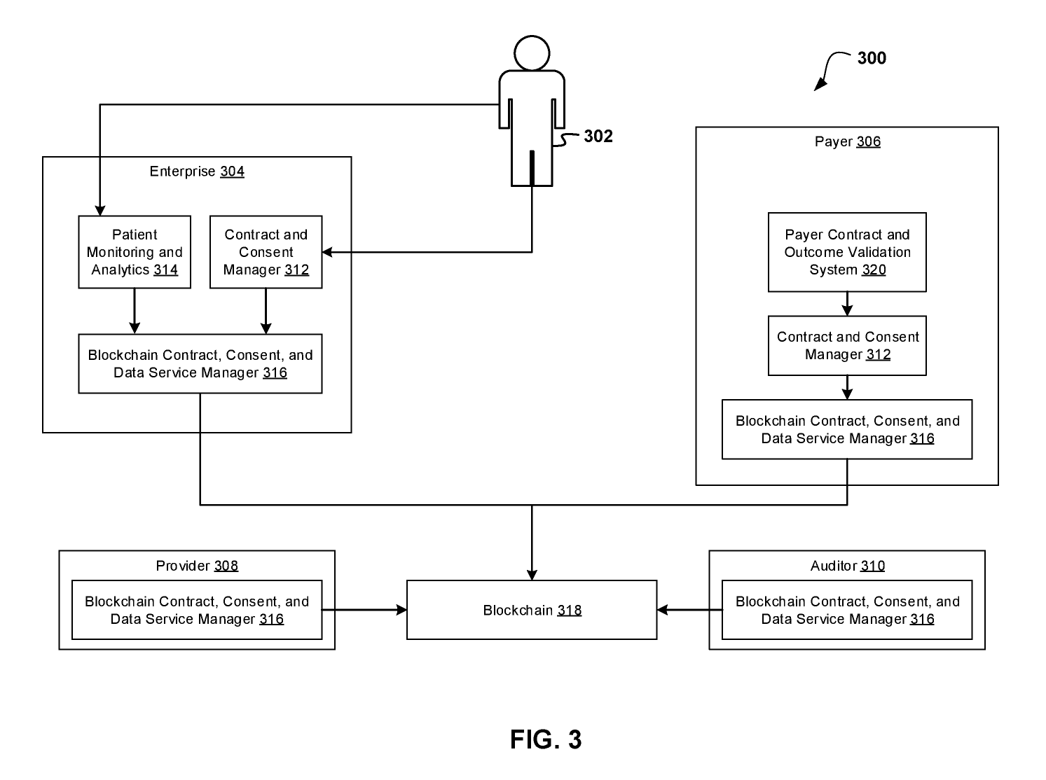

Referring now to FIG. 3, a functional block diagram 300 of an outcome-based contracting 300 is depicted, according to at least one embodiment. When a patient 302 begins a diagnosis regimen from a care provider 308 (e.g., receives a drug prescription), an enterprise 304 (e.g., a pharmaceutical company) may utilize a contract and consent manager 312 to generate a smart blockchain-based patient contract specific to the diagnosis regiment for the patient 302. In at least one embodiment, the contract and consent manager 312 may be a module of the outcome-based contract program 110A, 110B located on the enterprise side and the payer side of the system. The contract and consent manager 312 may obtain consent from the patient 302 to monitor patient data relevant to the diagnosis and disclose the monitored data to relevant individuals and entities (e.g., enterprise 304, payer 306, provider 308, and auditor 310). Once the patient contract is in effect, the patient monitoring and analytics 314 may be obtained from the patient 302 using data recording devices, such as mobile devices or wearable technology. Upon being received, the patient contract, patient consent, and monitored patient data may be stored in a blockchain 318 by a blockchain, contract, consent, and data service manager. Each stored item within the blockchain 318 may be accessed by the enterprise 304, payer 306, provider 308, and auditor 310 using each entity's corresponding blockchain contract, consent, and data service manager 316 to ensure data integrity and trustworthiness using a hash of the data within the blockchain. By utilizing blockchain 318, an audit trail may be established by chaining blocks together thus establishing an indelible trust between the data records stored within the blockchain. Upon satisfaction of the patient contract, the payer 306 may utilize a payer contract and outcome validation system 320 to retrieve the outcome data stored in the blockchain 318, validate the outcome data and payment per contract, and audit the trail of all data exchanges during the contract term.

It may be appreciated that FIGS. 2 and 3 provides only an illustration of one implementation and does not imply any limitations with regard to how different embodiments may be implemented. Many modifications to the depicted environments may be made based on design and implementation requirements. For example, in at least one embodiment, some elements of monitoring and analysis may be performed manually by any entity within the blockchain. In another embodiment, the outcome-based contract program 110A, 110B may be utilized for outcome-based contracts between payers and providers, or for payer authorization of continuation of treatment.

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the outcome-based contract program 110A in the client computing device 102 and the outcome-based contract program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the secure data request program 110A, 110B, can be stored on one or more of the respective portable computer-readable tangible storage devices 438, read via the respective R/W drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the outcome-based contract program 110A in the client computing device 102 and the outcome-based contract program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the outcome-based contract program 110A in the client computing device 102 and the outcome-based contract program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

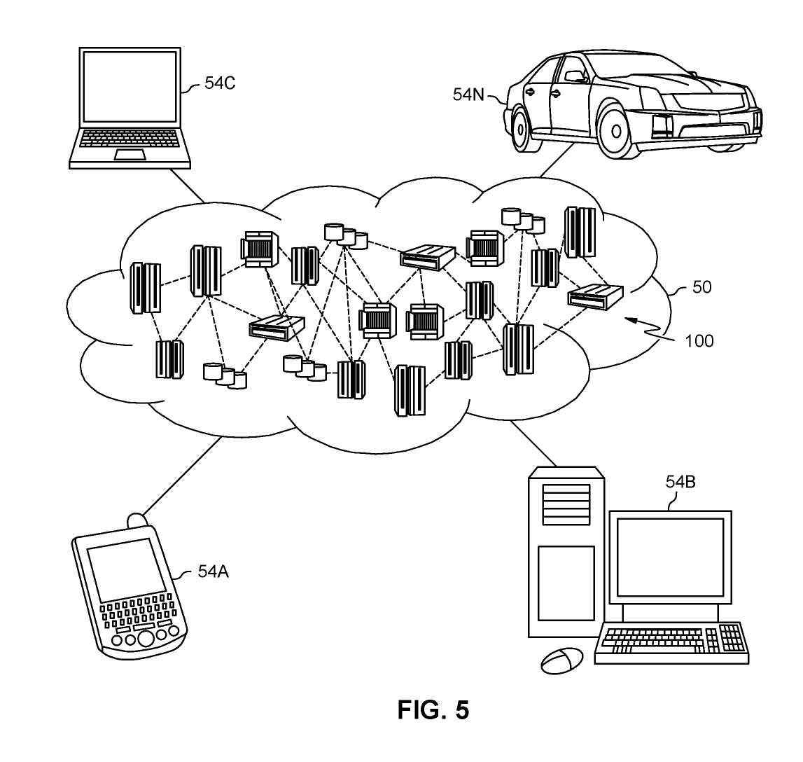

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

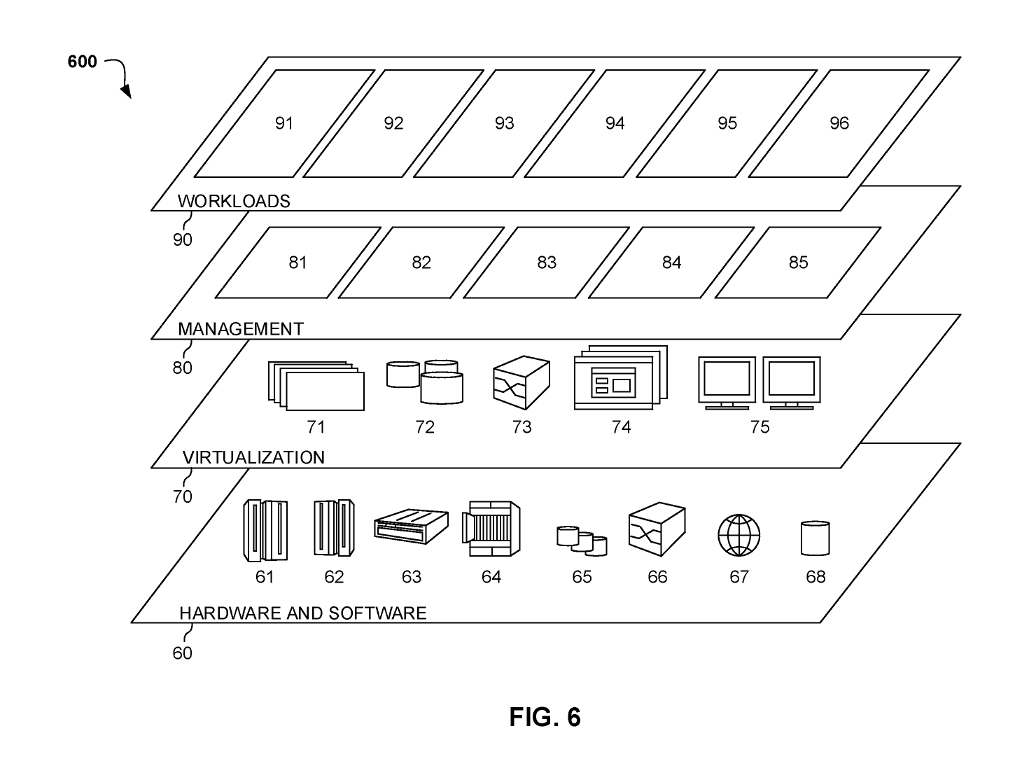

Referring now to FIG. 6, a set of functional abstraction layers 600 provided by cloud computing environment 50 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and outcome-based contracting 96. Outcome-based contracting 96 may relate defining a contract template between a pharmaceutical or medical device company and a payer, generating a patient contract based on the defined template, determining a patient has satisfied criteria of the patient contract, and processing a payment by the payer upon determination of the satisfied criteria.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for generating an outcome-based healthcare contract, the method comprising:
defining, by a processor, an outcome-based contract template between a company and a payer, wherein the defined outcome-based contract template comprises at least one category of a plurality of patient data to be tracked;
generating a contract for a patient based on the defined outcome-based contract template, wherein at least one specific value associated to the patient is assigned to each at least one category, and wherein the contract comprises a target outcome for the patient;
monitoring the plurality of patient data associated with the patient;
determining the target outcome is achieved based on the plurality of monitored patient data; and
transmitting a plurality of outcome data between the company and the payer based on the determined target outcome being achieved.

2. The method of claim 1, further comprises:
validating the target outcome and a payment by the payer based on the generated contract.

3. The method of claim 1, further comprising:
identifying the generated contract as a blockchain smart contract; and
computing the target outcome based on the plurality of monitored patient data using the blockchain smart contract, wherein, in response to the target outcome being achieved, the plurality of transmitted outcome data is transmitted between a plurality of authorized participants within a blockchain network.

4. The method of claim 1, wherein the company is selected from a group consisting of a pharmaceutical company and a medical device company.

5. The method of claim 1, further comprising:
de-identifying the plurality of patient data by removing one or more patient identifying items; and
storing the de-identified plurality of patient data in a repository.

6. The method of claim 1, wherein the outcome-based contract template comprises one or more diagnosis codes to which the outcome-based contract template correspond, a plurality of guidelines for drug administration under the one or more diagnosis codes, one or more outcome measurements, one or more outcome metrics, and a payment amount based on the one or more outcome measurements, one or more outcome metrics, and the plurality of guidelines.

7. The method of claim 2, wherein validating the target outcome and the payment through either a validation of each payment or a validation through a sampling methodology.

8. A computer system for generating an outcome-based healthcare contract, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
defining an outcome-based contract template between a company and a payer, wherein the defined outcome-based contract template comprises at least one category of a plurality of patient data to be tracked;
generating a contract for a patient based on the defined outcome-based contract template, wherein at least one specific value associated to the patient is assigned to each at least one category, and wherein the contract comprises a target outcome for the patient;
monitoring the plurality of patient data associated with the patient;
determining the target outcome is achieved based on the plurality of monitored patient data; and
transmitting a plurality of outcome data between the company and the payer based on the determined target outcome being achieved.

9. The computer system of claim 8, further comprises:
validating the target outcome and a payment by the payer based on the generated contract.

10. The computer system of claim 8, further comprising:
identifying the generated contract as a blockchain smart contract; and
computing the target outcome based on the plurality of monitored patient data using the blockchain smart contract, wherein, in response to the target outcome being achieved, the plurality of transmitted outcome data is transmitted between a plurality of authorized participants within a blockchain network.

11. The computer system of claim 8, wherein the company is selected from a group consisting of a pharmaceutical company and a medical device company.

12. The computer system of claim 8, further comprising:
de-identifying the plurality of patient data by removing one or more patient identifying items; and
storing the de-identified plurality of patient data in a repository.

13. The computer system of claim 8, wherein the outcome-based contract template comprises one or more diagnosis codes to which the outcome-based contract template correspond, a plurality of guidelines for drug administration under the one or more diagnosis codes, one or more outcome measurements, one or more outcome metrics, and a payment amount based on the one or more outcome measurements, one or more outcome metrics, and the plurality of guidelines.

14. The computer system of claim 9, wherein validating the target outcome and the payment through either a validation of each payment or a validation through a sampling methodology.

15. A computer program product for generating an outcome-based healthcare contract, the computer program product comprising:
one or more computer-readable tangible storage media and program instructions stored on at least one of the one or more tangible storage media, the program instructions executable by a processor of a computer to perform a method, the method comprising:
defining an outcome-based contract template between a company and a payer, wherein the defined outcome-based contract template comprises at least one category of a plurality of patient data to be tracked;
generating a contract for a patient based on the defined outcome-based contract template, wherein at least one specific value associated to the patient is assigned to each at least one category, and wherein the contract comprises a target outcome for the patient;
monitoring the plurality of patient data associated with the patient;
determining the target outcome is achieved based on the plurality of monitored patient data; and
transmitting a plurality of outcome data between the company and the payer based on the determined target outcome being achieved.

16. The computer program product of claim 15, further comprises:
validating the target outcome and a payment by the payer based on the generated contract.

17. The computer program product of claim 15, further comprising:
identifying the generated contract as a blockchain smart contract; and
computing the target outcome based on the plurality of monitored patient data using the blockchain smart contract, wherein, in response to the target outcome being achieved, the plurality of transmitted outcome data is transmitted between a plurality of authorized participants within a blockchain network.

18. The computer program product of claim 15, wherein the company is selected from a group consisting of a pharmaceutical company and a medical device company.

19. The computer program product of claim 15, further comprising:
de-identifying the plurality of patient data by removing one or more patient identifying items; and
storing the de-identified plurality of patient data in a repository.

20. The computer program product of claim 15, wherein the outcome-based contract template comprises one or more diagnosis codes to which the outcome-based contract template correspond, a plurality of guidelines for drug administration under the one or more diagnosis codes, one or more outcome measurements, one or more outcome metrics, and a payment amount based on the one or more outcome measurements, one or more outcome metrics, and the plurality of guidelines.
